(19) United States
(12) Patent Application Publication
(10) Pub. No.: US 2003/0172910 A1
(43) Pub. Date: Sep. 18, 2003

(54) Fuel injection system for an internal combustion engine

(76) Inventors: Patrick Mattes, Stuttgart (DE); Peter Boehland, Marbach (DE)

Correspondence Address: RONALD E. GREIGG, GREIGG & GREIGG P.L.L.C., Unit One, 1423 Powhatan Street, Alexandria, VA, 22314, US

(21) Appl. No.: 10/364,418

(22) Filed: Feb. 12, 2003

(30) Foreign Application Priority Data
Feb. 12, 2002 (DE) 1 02 05 749.4

(51) Int. Cl. F02M 47/02

(52) U.S. Cl. 123/447; 239/88; 123/446

(57) ABSTRACT

A fuel injection system having a high-pressure source and an injection valve having a pressure chamber communicating with the high-pressure source, and a valve member controlling at least one injection opening when acted upon by the pressure in the pressure chamber in an opening direction counter to a closing force. A control piston movable with the valve member in the closing direction defines a control pressure chamber which communicates with the high-pressure source and which has a communication controlled by an electrically actuated valve, with a relief chamber. The control valve is opened for fuel injection, so that the control pressure chamber communicates with the relief chamber. The valve member and the control piston move in the opening direction when the control valve is opened, and a limitation in the opening motion of the injection valve member and of the control piston is effected only by a pressure increase in the control pressure chamber from closure of the control valve.

### BACKGROUND OF THE INVENTION

1. Field of the Invention

The invention is directed to an improved fuel injection system for an internal combustion engine.

2. Description of the Prior Art

One known fuel injection system disclosed in European Patent Disclosure EP 0 987 431 A2 has a high-pressure source in the form of a high-pressure pump, and also has a fuel injection valve, which has a pressure chamber communicating with the high-pressure source. The fuel injection valve has an injection valve member, by which at least one injection opening is controlled, and which is movable by the pressure prevailing in the pressure chamber in the opening direction, counter to a closing force, to uncover the at least one injection opening. A control piston acting in a closing direction on the injection valve member is movable together with the injection valve member and defines a control pressure chamber that communicates with the high-pressure source. The control pressure chamber has a communication, controlled by an electrically actuated valve, with a relief chamber. The control valve, to open the fuel injection valve for fuel injection, is put in an opened switching position, so that the control pressure chamber communicates with the relief chamber. A motion of the injection valve member in the opening direction is limited by a stroke stop, on which the injection valve member comes to rest in a final stroke position. The contact of the injection valve member with this stroke stop causes irritating noise and moreover leads to pressure fluctuations, which in turn cause fluctuations in the quantity of fuel injected.

### OBJECT AND SUMMARY OF THE INVENTION

The fuel injection system of the invention has the advantage of causing less noise and of lessening fluctuations in the fuel injection quantity.

### BRIEF DESCRIPTION OF THE DRAWINGS

The invention will be better understood and further objects and advantages thereof will become more apparent from the ensuing detailed description of preferred embodimentS taken in conjunction with the drawings, in which:

FIG. 1 schematically shows a fuel injection system for an internal combustion engine in a first exemplary embodiment;

FIG. 2 shows an enlarged detail, marked II in FIG. 1, of the fuel injection system in a modified version;

FIG. 3 shows a course of a pressure at injection openings of a fuel injection valve in the fuel injection system; and

FIG. 4 schematically shows a fuel injection system in accordance with a second exemplary embodiment.

### DESCRIPTION OF THE PREFERRED EMBODIMENTS

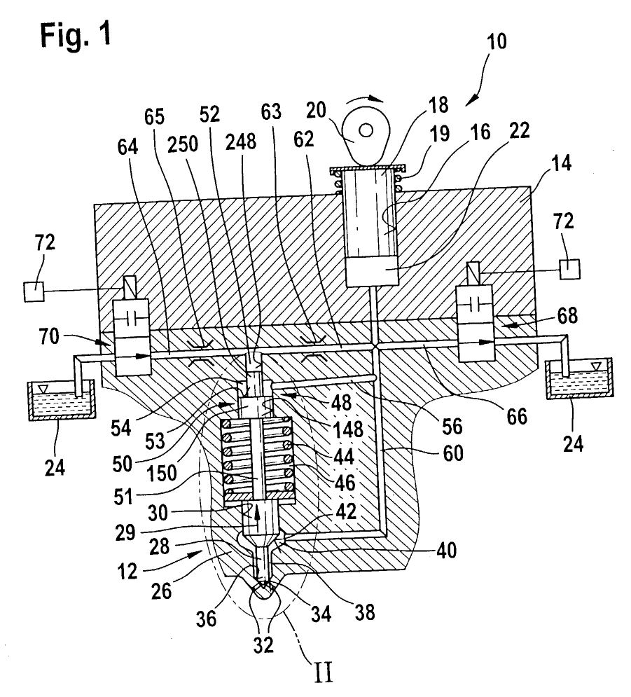

In FIG. 1, a fuel injection system for an internal combustion engine of a motor vehicle is shown in a first exemplary embodiment. The engine is preferably a self-igniting engine. The fuel injection system is preferably embodied as a so-called unit fuel injector and for each cylinder of the engine has one high-pressure fuel pump 10 and one fuel injection valve 12, communicating with it, which form a common structural unit. Alternatively, the fuel injection system can be embodied as a so-called pump-line-nozzle system, in which the high-pressure fuel pump and the fuel injection valve of each cylinder are disposed separately from one another and communicate with one another via a line. The high-pressure fuel pump 10 has a pump body 14 with a cylinder bore 16, in which a pump piston 18 is guided tightly; the pump piston is driven at least indirectly by a cam 20 of a camshaft of the engine, counter to the force of a restoring spring 19, to execute a reciprocating motion. The pump piston 18 defines a pump work chamber 22 in the cylinder bore 16; in the pump work chamber, fuel is compressed at high pressure in the pumping stroke of the pump piston 18. Fuel is delivered to the pump work chamber 22 from a fuel tank 24 of the motor vehicle.

The fuel injection valve 12 has a valve body 26, which is connected to the pump body 14 and can be embodied in multiple parts, and in which an injection valve member 28 is guided longitudinally displaceably in a bore 30. In its end region, toward the combustion chamber of the cylinder of the engine, the valve body has at least one injection opening and preferably a plurality of injection openings 32. The injection valve member 28, in its end region toward the combustion chamber, has a pressure face 34, which is for instance approximately conical, which cooperates with a valve seat 36, embodied in the valve body 26 in its end region toward the combustion chamber, and the injection openings 32 lead away from or downstream of this valve seat. An annular chamber 38 is present in the valve body 26, between the injection valve member 28 and the bore 30, toward the valve seat 36, and in its end region remote from the valve seat 36, it changes over, as a result of a radial widening of the bore 30, into a pressure chamber 40 surrounding the injection valve member 28. At the level of the pressure chamber 40, the injection valve member 28 has a pressure shoulder 42 as a result of a cross-sectional reduction. The end of the injection valve member 28 remote from the combustion chamber is engaged by a prestressed closing spring 44, by which the injection valve member 28 is pressed toward the valve seat 36. The closing spring 44 is disposed in a spring chamber 46 of the valve body 26, which chamber adjoins the bore 30.

The spring chamber 46 is adjoined, on its end remote from the bore 30, in the valve body 26 by a further bore 48, in which a control piston 50 that is connected to the injection valve member 28 is guided tightly. The bore 48 is embodied with a graduated diameter and has one portion 148 of large diameter, disposed toward the spring chamber 46, and one portion 248 of small diameter, disposed remote from the spring chamber 46. The control piston 50 is correspondingly embodied with a graduated diameter as well, and has one region 150 of large diameter that is tightly guided in the bore portion 148 and another region 250 of small diameter that is tightly guided in the bore portion 248. In the bore portion 248, a control pressure chamber 52 is defined by the end face of the region 250 of the control piston 50, acting as a movable wall. At the transition between the regions 150, 250, an annular pressure face 53 is formed at the region 150 of the control piston 50; with this pressure face, the region 150 of the control piston 50 defines a further pressure chamber 54 in the bore portion 148. The control piston 50 is connected to the injection valve member 28 via a piston rod 51 whose diameter is smaller than that of the control piston. The control piston 50 may be embodied integrally with the injection valve member 28, but for reasons of assembly it is preferably connected as a separate part to the injection valve member 28.

From the pump work chamber 22, a conduit 60 leads through the pump body 14 and the valve body 26 to the pressure chamber 40 of the fuel injection valve 12. From the pump work chamber 22 or from the conduit 60, a conduit 62 leads to the control pressure chamber 52. Also discharging into the control pressure chamber 52 is a conduit 64, which forms a communication with a relief chamber, as which the fuel tank 24, or some other region in which a low pressure prevails, can serve, at least indirectly. A communication 66 leads from the pump work chamber 22 or from the conduit 60 to a relief chamber 24, and is controlled by a first electrically actuated valve 68. The control valve 68 may, as shown in FIG. 1, be embodied as a 2/2-way valve. The communication 64 of the control pressure chamber 52 with the relief chamber 24 is controlled by a second electrically actuated valve 70, which may be embodied as a 2/2-way valve. A throttle restriction 63 is provided in the communication 62 of the control pressure chamber 52 with the pump work chamber 22, and a throttle restriction 65 is provided in the communication of the control pressure chamber 52 with the relief chamber 24. By suitable dimensioning of the throttle restrictions 63, 65, the inflow of fuel from the pump work chamber 22 into the control pressure chamber 52 and the outflow of fuel from the control pressure chamber 52 can be adjusted to a requisite extent. An adequate inflow of fuel into the control pressure chamber 52 is required for fast closure of the fuel injection valve 12, and an adequate outflow of fuel from the control pressure chamber 52 is required for fast opening of the fuel injection valve 12. The control valves 68, 70 may have an electromagnetic actuator or a piezoelectric actuator and are triggered by an electronic control unit 72.

The further pressure chamber 54 has a communication 56, for instance in the form of a conduit, with the pump work chamber 22, and this communication can for instance discharge into the conduit 62. There is no throttle restriction in the communication 56. The further pressure chamber 54 thus communicates directly with the pump work chamber 22, circumventing the throttle restriction 63 of the communication 62 of the control pressure chamber 52 with the pump work chamber 22, and the same pressure acts on the pressure face 53 of the control piston 50 as in the pump work chamber 22 and in the pressure chamber 40. By means of the pressure prevailing in the further pressure chamber 54, via the pressure face 53 on the control piston 50, a force in the closing direction on the injection valve member 28 that reinforces the closing spring 44 is generated. By means of the pressure prevailing in the control pressure chamber 52, via the end face of the control piston 50, a force in the closing direction on the injection valve member 28 that reinforces the closing spring 34 is likewise generated. By means of the second control valve 70, the pressure in the control pressure chamber 52 is controlled; when the control valve 70 is closed, at least approximately the same pressure is established in the control pressure chamber 52 as in the pump work chamber 22 and as in the further pressure chamber 54, while when the control valve 70 is open, because of the communication with the relief chamber 24, a lesser pressure is established in the control pressure chamber 52. The total closing force acting on the injection valve member 28 is thus dependent on the force of the closing spring 44, on the pressure prevailing in the control pressure chamber 52, which pressure is controlled by the second control valve 70, and on the pressure prevailing in the further pressure chamber 54, which is equal to the pressure prevailing in the pump work chamber 22, which in turn is dependent on the pumping stroke of the pump piston 18.

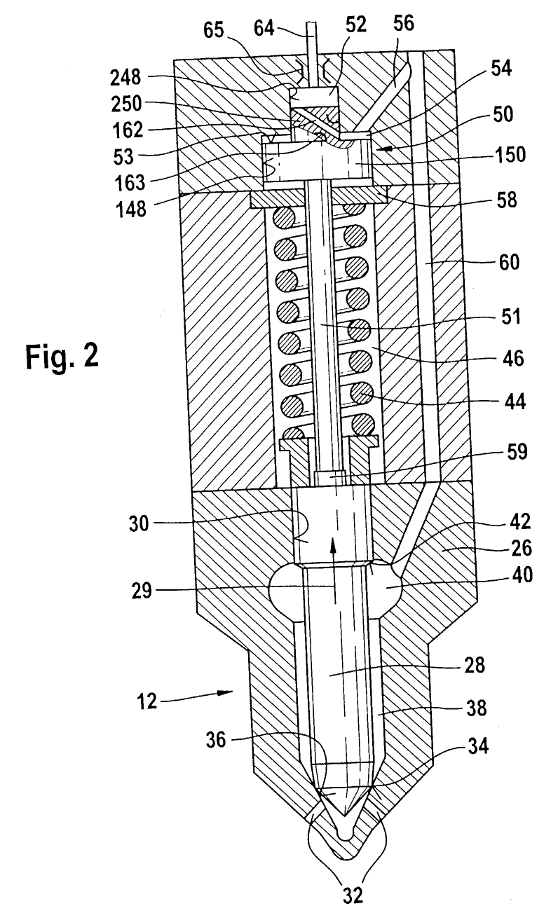

In FIG. 2, a modified version of the fuel injection system is shown in the form of a detail; its basic structure is the same as in the embodiment of FIG. 1, except that the embodiment of the control piston and the connection of the control pressure chamber 52 to the pump work chamber 22 are modified. Once again, the control piston 50 has the region 150 guided tightly in the bore portion 148 of larger diameter and the region 250 guided tightly in the bore portion 248 of smaller diameter. By means of the end face of the control piston region 250, the control pressure chamber 52 is defined, and by means of the annular pressure face 53 of the control piston region 150, the further pressure chamber 54 is defined. The further pressure chamber 54 communicates via the communication 56 with the conduit 60 and via this conduit with the pump work chamber 22. A communication 162, for instance in the form of a bore, is formed in the control piston region 250, and through it the control pressure chamber 52 communicates with the further pressure chamber 54. A throttle restriction 163 is provided in the communication 162; it may be formed by the communication 162 itself, if this communication is embodied with a suitably small cross section. From the control pressure chamber 52, the communication 64, which is controlled by the second control valve 70 and in which the throttle restriction 65 is provided, leads away to the relief chamber 24. In a distinction from the version of FIG. 1, the bore portion 148 has the same diameter as the spring chamber 46. For the sake of separation between the bore portion 148 and the spring chamber 46, a shim 58 is provided, on which the closing spring 44 is braced in the spring chamber 46. A compensation disk 59 can be disposed between the piston rod 51 and the injection valve member 28; with it, the spacing between the control piston 50 and the injection valve member 28 can be adjusted.

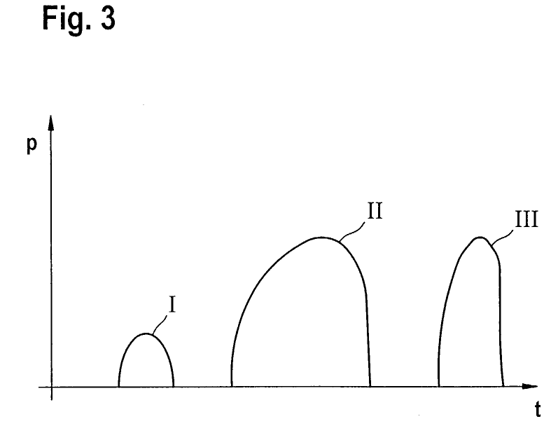

The function of the fuel injection system will now be described. In FIG. 3, the course of the pressure p at the injection openings 32 of the fuel injection valve 12 is plotted over time t during one injection cycle. In the intake stroke of the pump piston 18, fuel is delivered to the pump piston from the fuel tank 24. In the pumping stroke of the pump piston 18, the fuel injection begins with a preinjection, in which the first control valve 68 is closed by the control unit 72, so that the pump work chamber 22 is disconnected from the relief chamber 24. The control 72 also opens the second control valve 70, so that the control pressure chamber 52 communicates with the relief chamber 24. In this case, a high pressure cannot build up in the control pressure chamber 52, since this control pressure chamber is relieved to the relief chamber 24. However, a slight fuel quantity can flow out of the pump work chamber 22 to the relief chamber 24 via the throttle restrictions 63 and 65, so that the full high pressure that would build up if the second control valve 70 were closed cannot build up in the pump work chamber 22. The same pressure prevails in the further pressure chamber 54 as in the pump work chamber 22 and the pressure chamber 40. If the pressure in the pump work chamber 22 and thus in the pressure chamber 40 of the fuel injection valve 12 is so great that the pressure force exerted by the fuel injection valve on the injection valve member 28 via the pressure shoulder 42 is greater than the total force of the closing spring, the pressure force acting on the control piston 50 as a result of the residual pressure operative in the control pressure chamber 52, and the pressure force generated by the pressure prevailing in the further pressure chamber 54 via the pressure face 53, then the injection valve member 28 moves in the opening direction 29 and uncovers the at least one injection opening 32. To terminate the preinjection, the second control valve 70 is closed by the control unit, so that the control pressure chamber 52 is disconnected from the relief chamber 24. The first control valve 68 remains in its closed position. High pressure builds up in the control pressure chamber 52 as in the pump work chamber 22, so that a great pressure force in the closing direction acts on the control piston 50. Moreover, with the second control valve 70 closed, the pressure in the pump work chamber 22 and thus also in the further pressure chamber 54 rises, so that also via the pressure face 53, an increased force in the closing direction on the injection valve member 28 is generated. Since now the force acting on the injection valve member 28 in the opening direction 29 is less than the sum of the force of the closing spring 44, the pressure force on the control piston 50, and the pressure force on the pressure face 53, the fuel injection valve 12 closes. The preinjection corresponds to an injection phase marked I in FIG. 3.

For an ensuing main injection, which corresponds to an injection phase II in FIG. 3, the second control valve 70 is opened by the control unit 72, so that the pressure in the control pressure chamber 52 drops. Then as a consequence of the reduced pressure force on the control piston 50, the fuel injection valve 12 opens, and the injection valve member 28 moves for the length of its maximum opening stroke. No stroke stop is provided for limiting the opening reciprocating motion of the injection valve member 28 and of the control piston 50. The opening reciprocating motion of the injection valve member 28 and the control piston 50 ends when the injection valve member 28 and the control piston 50 are in force equilibrium, or in other words when the force generated on the injection valve member 28 in the opening direction 29 by the pressure prevailing in the pressure chamber 40 is equal to the force acting in the closing direction, which is the total of the force generated by the closing spring 44, the force generated via the pressure face 53 by the pressure prevailing in the further pressure chamber 54, and the force generated via the end face of the control piston 50 by the residual pressure prevailing in the control pressure chamber 52. Approximately, the injection valve member 28 and the control piston 50 are in an opening reciprocating motion as long as the force acting in the opening direction 29 is greater than the force acting in the closing direction. If after the closure of the second control valve 70 the forces acting in the closing direction become greater than the force acting in the opening direction 29, then the motion of the injection valve member 28 and of the control piston 50 in the opening direction 29 is delayed, until finally the direction of motion is reversed, and the control piston 50 and the injection valve member 28 then move toward the valve seat 36 again, in the closing direction. The length of time during which the injection valve member 28 and the control piston 50 move in the opening direction 29, and thus the opening stroke, are dependent on the engine rpm and increase as the rpm increases, because of the shortening of the time then available for the opening stroke. The motion of the control piston 50 and thus also of the injection valve member 28 in the opening direction 29 can be restricted by its contact with the boundary of the further pressure chamber 54 or the boundary of the control pressure chamber 52, but when the fuel injection system and the engine are functioning properly, the control piston 50 does not come into contact there.

When the control valve 70 is open, a slight fuel quantity flows out to the relief chamber 24 via the throttle restrictions 63, 65, but the throttle restrictions 63, 65 can be embodied with a small flow cross section, so that the outflowing fuel quantity and the reduction in the pressure in the pump work chamber 22 are only slight.

To terminate the main injection, the second control valve 70 is put in its closed switching position by the control unit 72, so that the control pressure chamber 52 is disconnected from the relief chamber 24, and a high force in the closing direction acts on the control piston 50, so that the fuel injection valve 12 closes. This can also be followed by a postinjection, for which the second control valve 70 is opened again by the control unit 72, so that the fuel injection valve 12 opens again as a consequence of the reduced force on the control piston 50 in the closing direction. To terminate the postinjection, the first control valve 68 is opened by the control unit 72, so that the pump work chamber 22 communicates with the relief chamber 24, and now only a slight pressure force acts on the injection valve member 28 in the opening direction 29, and the fuel injection valve 12 closes, because of the force of the closing spring 44, the force generated on the control piston 50 by the residual force prevailing in the control pressure chamber 52, and the force generated on the pressure face 53 in the further pressure chamber 54. For terminating the postinjection, the second control valve 70 may be in either its open or closed position. The postinjection is equivalent to an injection phase III in FIG. 3.

In the embodiments described above of the fuel injection system, it can additionally be provided that the flow cross section from the control pressure chamber 52 to the relief chamber 24 is controlled in a variable way by the control piston 50, as a function of the control piston stroke. By means of the control piston 50, in a stroke position corresponding to the closed position of the injection valve member 28, a large flow cross section can be uncovered, while in a stroke position corresponding to the open position of the injection valve member 28, a small flow cross section can be uncovered.

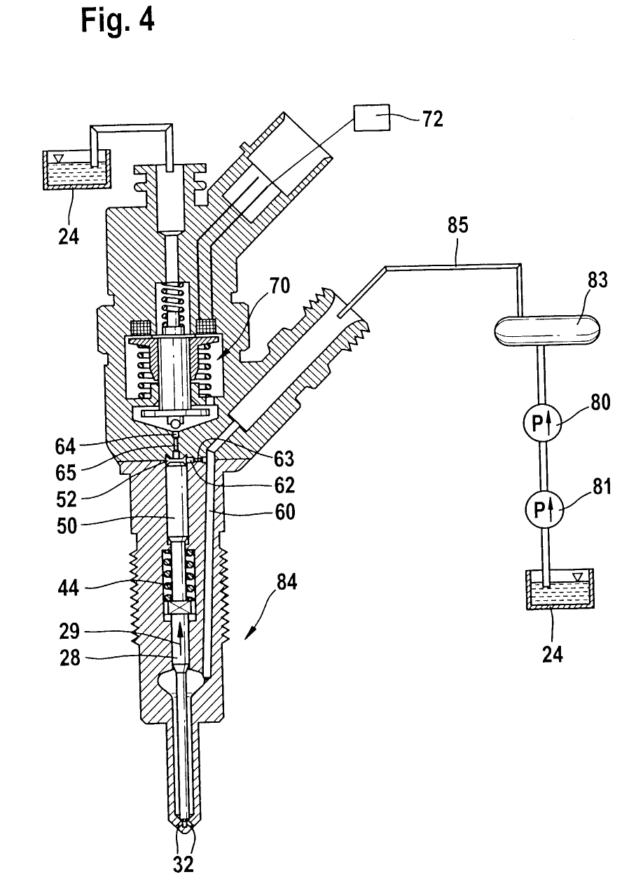

In FIG. 4, the fuel injection system is shown in a second exemplary embodiment. The fuel injection system has a high-pressure pump 80, by which fuel is pumped into a reservoir 83. Fuel from a fuel tank 24 is delivered to the high-pressure pump 80 by means of a feed pump 81. High pressure always prevails in the reservoir 83; this high pressure can be variable, depending on engine operating parameters. A plurality of fuel injection valves 84 communicate with the reservoir, and one fuel injection valve 84 is provided for each cylinder of the engine. The reservoir 83 is intended for a plurality of fuel injection valves 84, for instance for all of them, of the engine. The fuel injection valve 84 is constructed essentially the same as in the first exemplary embodiment, and so its basic construction need not be described again here, and the same reference numerals are used as in the first exemplary embodiment. The fuel injection valve 84 has the pressure chamber 40, which communicates with the reservoir 83, as the high-pressure source, via a line 85. Thus high pressure constantly prevails in the pressure chamber 40, as in the reservoir 83. The line 85 is connected to a connection on the valve body 26 of the fuel injection valve 84 and leads in the form of a conduit 60 in the valve body 26 to the pressure chamber 40. The control piston 50 that is movable together with the injection valve member 28 is provided on the fuel injection valve 84 and defines the control pressure chamber 52. The injection valve member 28 is also engaged by the closing spring 44. The control pressure chamber 52 has the communication 62 with the conduit 60 and thus with the reservoir 83 as the high-pressure source, in which the throttle restriction 63 is provided. The control pressure chamber 52 also has the communication 64 with the relief chamber 24, in which the throttle restriction 65 is provided, and which is controlled by the control valve 70.

When the control valve 70 is closed, the control pressure chamber 52 is disconnected from the relief chamber 24, so that in it, high pressure prevails as in the reservoir 83, and by the force acting on the control piston 50, the fuel injection valve 84 is kept closed, so that no fuel injection occurs. For a preinjection of a slight fuel quantity, the control valve 70 is opened for a brief time by the control unit 72, so that the control pressure chamber 52 is relieved, and the injection valve member 28, because of the lesser closing force acting on it, moves in the opening direction 29 and uncovers the injection openings 32. To terminate the preinjection, the control valve 70 is closed again by the control unit 72, so that as a consequence of the increased force in the closing direction, the fuel injection valve 84 closes again.

For a subsequent main injection, the control valve 70 is opened again by the control unit 72, so that the fuel injection valve 84 opens because of the lesser force in the closing direction. No stroke stop is provided for limiting the opening reciprocating motion of the injection valve member 28 and control piston 50. The opening reciprocating motion of the injection valve member 28 and control piston 50 ends when the injection valve member 28 and the control piston 50 are in force-equilibrium; that is, when the force in the opening direction 29 on the injection valve member 28 generated by the pressure prevailing in the pressure chamber 40 is equal to the force acting in the closing direction, which latter force is the sum of the force generated by the closing spring 44 and the force, generated by the residual force prevailing in the control pressure chamber 52, via the end face of the control piston 50. The injection valve member 28 and the control piston 50 are approximately in an opening reciprocating motion as long as the force acting in the opening direction 29 is greater than the force acting in the closing direction. If after the closure of the control valve 70 the forces acting in the closing direction become greater than the force acting in the opening direction 29, then the motion of the injection valve member 28 and control piston 50 in the opening direction 29 is delayed, until finally the direction of motion is reversed, and the control piston 50 and the injection valve member 28 move again in the closing direction toward the valve seat 36. The length of time during which the injection valve member 28 and the control piston 50 move in the opening direction 29, and thus the opening stroke, are dependent on the engine rpm and increase with increasing rpm, because of the reduction in the length of time then available for the opening stroke. The motion of the control piston 50 and thus also of the injection valve member 28 in the opening direction 29 can be restricted by its contact with the boundary of the control pressure chamber 52, but the control piston 50 does not come into contact there, when the fuel injection system and the internal combustion engine are functioning properly.

Because no fixed stroke stop is provided for the injection valve member 28, lesser pressure pulsations are caused in the low-pressure loop of the fuel injection system, which is formed by the return from the fuel injection valve 84 and by the region between the fuel tank 24 and the high-pressure pump 80. Lesser temperatures also result in the low-pressure loop, so that no fuel cooler is required. A higher total efficiency of the high-pressure system, which is the high-pressure pump 80 and the region between the high-pressure pump 80 and the fuel injection valve 84, is also obtained. A smaller, less expensive high-pressure pump 80 can therefore be used. With the omission of the fixed stroke stop and the elimination of complicated adjustment work on it, the fuel injection valve 84 can be manufactured more economically. If there were a fixed stroke stop for the injection valve member 28, then after the injection valve member 28 contacted the stroke stop, the length of time for which the control valve 70 would have to be opened for the fuel injection would have to be lengthened, causing a correspondingly larger fuel quantity to flow out via the opened control valve 70, and correspondingly worsening the efficiency of the fuel injection system. Moreover, that causes a kink in the characteristic quantity curve of the fuel injection valve 84, or in other words in the fuel injection quantity plotted over the opening duration of the control valve 70. With the omission of the fixed stroke stop, this kink in the characteristic quantity curve of the fuel injection valve 84 can be avoided, since the injection valve member 28 has a ballistic motion over its entire stroke.

The foregoing relates to preferred exemplary embodiments of the invention, it being understood that other variants and embodiments thereof are possible within the spirit and scope of the invention, the latter being defined by the appended claims.

We claim:

1. In a fuel injection system for an internal combustion engine, having a high-pressure source (10; 83) and a fuel injection valve (12; 84), communicating with it, that has a pressure chamber (40), communicating with the high-pressure source (10; 83), and an injection valve member (28), by which at least one injection opening (32) is controlled and which is movable, acted upon by the pressure prevailing in the pressure chamber (40), in an opening direction (29) counter to a closing force in order to uncover the at least one injection opening (32); having a control piston (50), acting in a closing direction on the injection valve member (28), that is movable together with the injection valve member (28) and that defines a control pressure chamber (52), which communicates at least indirectly with the high-pressure source (10; 83) and which has a communication (64), controlled by an electrically actuated valve (70), with a relief chamber (24), the control valve (70) being opened for fuel injection so that the control pressure chamber (52) communicates with the relief chamber (24), the improvement wherein the injection valve member (28) and the control piston (50) are movable in the opening direction (29) when the control valve (70) is opened, and wherein a limitation in the opening motion of the injection valve member (28) and of the control piston (50) is effected only as a consequence of a pressure increase in the control pressure chamber (52) from closure of the control valve (70).

2. The fuel injection system of claim 1, wherein neither the injection valve member (28) nor the control piston (50) come to rest against a fixed stop in the opening direction (29).

3. The fuel injection system of claim 1, further comprising one throttle restriction (63; 65) each disposed in the communication (62) of the control pressure chamber (52) with the high-pressure source (10; 83) and in the communication (64) of the control pressure chamber (52) with the relief chamber (24).

4. The fuel injection system of claim 2, further comprising one throttle restriction (63; 65) each disposed in the communication (62) of the control pressure chamber (52) with the high-pressure source (10; 83) and in the communication (64) of the control pressure chamber (52) with the relief chamber (24).

5. The fuel injection system of claim 1, further comprising a reservoir (83) serving as the high-pressure source, a high-pressure pump (80) operable to pump fuel into the reservoir (83), one common reservoir (83) being provided for a plurality of cylinders of the engine.

6. The fuel injection system of claim 2, further comprising a reservoir (83) serving as the high-pressure source, a high-pressure pump (80) operable to pump fuel into the reservoir (83), one common reservoir (83) being provided for a plurality of cylinders of the engine.

7. The fuel injection system of claim 3, further comprising a reservoir (83) serving as the high-pressure source, a high-pressure pump (80) operable to pump fuel into the reservoir (83), one common reservoir (83) being provided for a plurality of cylinders of the engine.

8. The fuel injection system of claim 1, further comprising a high-pressure pump (10) serving as the high-pressure source, the pump (10) having a pump piston (18) driven in a reciprocating motion by the engine and defining a pump work chamber (22) with which the pressure chamber (40) of the fuel injection valve (12) communicates, a separate high-pressure pump (10) being provided for each cylinder of the engine.

9. The fuel injection system of claim 2, further comprising a high-pressure pump (10) serving as the high-pressure source, the pump (10) having a pump piston (18) driven in a reciprocating motion by the engine and defining a pump work chamber (22) with which the pressure chamber (40) of the fuel injection valve (12) communicates, a separate high-pressure pump (10) being provided for each cylinder of the engine.

10. The fuel injection system of claim 3, further comprising a high-pressure pump (10) serving as the high-pressure source, the pump (10) having a pump piston (18) driven in a reciprocating motion by the engine and defining a pump work chamber (22) with which the pressure chamber (40) of the fuel injection valve (12) communicates, a separate high-pressure pump (10) being provided for each cylinder of the engine.

11. The fuel injection system of claim 8, further comprising a further pressure chamber (54) communicating with the pump work chamber (22), the pressure chamber (54) being defined by a pressure face (53), by way of which face a further force on the injection valve member (28) in the closing direction is generated.

12. The fuel injection system of claim 11, wherein the pressure face (53) is embodied on the control piston (50), which is embodied with a graduated cross section; wherein the control piston (50) and the end face of a region (250) of small cross section define the control pressure chamber (52); and wherein the pressure face (53) is embodied as an annular face at a region (150) of large cross section of the control piston (50), at the transition to the region (250) of the small cross section.

13. The fuel injection system of claim 11, wherein the further pressure chamber (54) communicates directly with the pump work chamber (22), circumventing the communication (62) of the control pressure chamber (52) with the pump work chamber (22).

14. The fuel injection system of claim 12, wherein the further pressure chamber (54) communicates directly with the pump work chamber (22), circumventing the communication (62) of the control pressure chamber (52) with the pump work chamber (22).

15. The fuel injection system of claim 11, wherein the control pressure chamber (52) communicates with the pump work chamber (22) via the further pressure chamber (54), and wherein the throttle restriction (163) is disposed in the communication (162) between the control pressure chamber (52) and the further pressure chamber (54).

16. The fuel injection system of claim 12, wherein the control pressure chamber (52) communicates with the pump work chamber (22) via the further pressure chamber (54), and wherein the throttle restriction (163) is disposed in the communication (162) between the control pressure chamber (52) and the further pressure chamber (54).

17. The fuel injection system of claim 15, wherein the communication (162) of the control pressure chamber (52) with the further pressure chamber (54) is effected via at least one conduit in the control piston (50).

18. The fuel injection system of claim 16, wherein the communication (162) of the control pressure chamber (52) with the further pressure chamber (54) is effected via at least one conduit in the control piston (50).

19. The fuel injection system of claim 8, wherein the high-pressure pump (10) and the fuel injection valve (12) form a common structural unit.

20. The fuel injection system of claim 15, wherein the high-pressure pump (10) and the fuel injection valve (12) form a common structural unit.
